(19) United States
(12) Patent Application Publication
(10) Pub. No.: US 2013/0247462 A1
(43) Pub. Date: Sep. 26, 2013

(54) Watering and Drainage Arrangement for a Multi-Layer Horticultural Structure

(71) Applicant: Michael John Leslie, Palmwoods (AU)

(72) Inventor: Michael John Leslie, Palmwoods (AU)

(73) Assignee: Vertical Farm Systems Pty Ltd, Palmwoods (AU)

(21) Appl. No.: 13/823,808

(22) PCT Filed: Sep. 27, 2011
(86) PCT No.: PCT/AU2011/001240

§ 371 Date: Mar. 15, 2013

(30) Foreign Application Priority Data
Sep. 29, 2010 (AU) 2010904371

(51) Int. Cl. A01G 9/24

(52) U.S. Cl. CPC A01G 9/247
USPC 47/82

(57) ABSTRACT

A watering/drainage arrangement for a multi-layer horticultural structure wherein during watering, water from a series of water release outlets is sprayed through an aperture of a flood tray which fills to a selected level and maintained at this level by the continued supply of sprayed water through the water release outlets and the drainage of overflow via a weir edge of the flood tray and during drainage, supply of water to the release outlets is terminated thereby preventing water being sprayed into the aperture of the flood tray thereby allowing the discharge of water through the aperture of the flood tray.

### FIELD OF THE INVENTION

This invention relates to multi-layer horticultural structures which are in many instances generically referred to as vertical farm systems.

More particularly this invention is in relation to a very unique and effective watering and water drainage arrangement for such multi-layer horticultural structures that are able to provide for effective watering and drainage simultaneously and precisely to all the individual trays that make up the multi-layer horticultural structure without the requirement of complex flow control valves and mechanisms that one would expect from such a system that is adapted to provide such simultaneous and precise flooding and draining for the respective trays withinside a column of the multi-layer horticultural structure per se.

### BACKGROUND DISCUSSION

Pressures on food growing are increasing around the world as a result of continuing population growth, widespread degradation of arable land, accelerating climate changes, unpredictable water availability and an established trend for people to live and work in cities rather than rural environments.

These issues are now demanding a significant step change in the methodologies and technologies previously used for horticultural. One of the most promising developments in this area is the enclosed environment cultivation of plants.

While environmentally controlled farming originally has been used in a single layer greenhouse environment the recent further innovation of multi-layer growing using advanced low energy lighting has many advantages.

However certain design challenges present themselves in deployment of multi-layer horticulture especially concerning the requirement for precisely regulating watering of the crops being grown without restricting access to the crops themselves or requiring the use of large numbers of active mechanical or servo-electric components with their attendant maintenance overhead and undesirable failure modes.

A further challenge associated with these vertical farming systems that present multi-layer horticultural structures is the requirement that high density horticultural environments by necessity must have extreme levels of cleanliness to prevent introduction or propagation of harmful algae and/or bacteria into the entire growing environment with potential severe financial results and even fatal human repercussions if such requirements and safety standards are not met.

Therefore the watering and in fact the water drainage arrangement for these multi-layer horticultural structures is paramount but as introduced above the ability to control these must be able to be provided for if costs, maintenance, consistency, efficiency and reproducibility is to be maintained needs to be done so without complex water regulators, shut-off valves as well as the associated mechanical and/or servo-electric components which would need to be instigated in order to provide adequate watering and drainage to the respective trays that make up the multi-layer horticultural structure.

It is therefore an object of this invention to provide a watering and water drainage arrangement for a multi-layer horticultural structure that can overcome at least some of the problems referred to above or at least provide the public with a useful alternative to existing watering and water drainage arrangements used with the conventional multi-layer horticultural structure units.

### SUMMARY OF THE INVENTION

Accordingly in one form of the invention there is provided a watering and water drainage arrangement for a multi-layer horticultural structure, said arrangement including;

a water supply network piping wherein said water supply network piping includes a series of water release outlets;

at least one water receiving, storage and/or water flood tray per layer of said multi-layer horticultural structure;

each flood tray of each layer of the multi-layer horticultural structure including an overflow level arrangement so that water introduced into the flood tray is unable to exceed the desirable pre-selected level as water will flow over a shoulder and/or weir edge so as not to allow the water level within the flood tray to surpass said set or desired water level;

said water flood tray further including an aperture to which flowing water may be introduced and passed or drained therethrough;

said water release outlets configured so that upon supply of water to the water supply network piping water is jetted, sprayed, shot and/or flowed from a distance into said flood tray aperture,

such that when watering is required within the multi-layer horticultural structure the forceful or pumped release of water throughout the water supply network piping jets from the series of water release outlets water in the direction of the aperture of the water flood tray so that water flows through said aperture so as to fill the water flood tray to the required level and when water level with inside the water flood tray reaches the desired or selected level this level is maintained by the continued supply of water from the water supply network piping water release outlet through the aperture of the flood tray while at the same time any additional delivery of water from the water supply network piping once the desired or selected water level is reached sees a corresponding drainage or release of water from the overflow shoulder and/or weir edge of the flood tray,

and such That when drainage of water is required from the water flood tray, supply of water to the release outlets is terminated by removing the supply of water from the water supply network piping to allow the discharge of water through the aperture of the water flood tray.

As the person skilled in the art will immediately see from the broad description of the invention what is very unique to this invention is its ability to sequentially and precisely flood into or drain from the respective flood trays that make up the multi-layer horticultural structure.

As there is a simple but uniquely configured water supply network piping which allows for a series of water release outlets to correspond or to align with an aperture of the flood tray, once water needs to be introduced into the multi-layer horticultural structure it can be done so simultaneously throughout each of the water release outlets that are part of the water supply network piping.

As water is being jetted, sprayed, shot and/or flowed from the release outlet of the water supply network piping into the aperture of each flood tray this effectively blocks said aperture thus preventing any water to simultaneously drain from the same aperture of the flood tray while said jetting into the aperture is in progress.

Advantageously to maintain a required soakage time for optimum plant watering, once the desired level of water within the flood tray has been reached rather than shutting off the water supply which would then require the shutting or closing off of the aperture within the flood tray to which water is being introduced, water is still directed into the flood tray and this continual supply of water is counter-acted upon by the overflow level arrangement withinside the flood tray which simply allows the excess of water to be considered overflow to which it is then discharged from the flood tray.

As each of the flood trays will be configured with substantially the same dimensions no single tray is able to receive any greater depth of water or be watered for any longer period of time than another. Once the water supply is removed from the water supply network piping all water release outlets no longer have the ability to jet, spray or shoot water into the aperture of the flood tray so accordingly all flood trays simultaneously will then begin to drain at the same rate as the apertures are of a comparable diameter.

In preference the water release outlet is a cylindrical nozzle.

An advantage of such an arrangement is that by having a cylindrical nozzle the diameter and the length of the nozzle Can influence the direction, degree and quantity of flow therethrough which will influence the pressure hold upon the flood tray aperture to prevent water from draining thereout said aperture when watering and maintaining of water level is required for the system.

In preference the aperture provides a selectable diameter.

An advantage of such an arrangement is that by being able to control the supply of water into the flood tray through flow rates and pressure etc. from the design of the nozzle preferred filling times can be more consistently provided for.

At the same time by the selection of an appropriate diameter of the aperture for the flood tray means that the amount of flow from the selected diameter of the aperture will relate to the time it takes to drain each individual flood tray.

Advantageously the supply of water to the flood tray, the maintenance of the water withinside the flood tray to the required water level as well as ultimately the drainage of the water as a discharge through the aperture of the flood tray is all achieved without any individual water valve control of each of the flood trays.

The unique structural arrangement of the nozzle and the aperture provides all the control necessary for the appropriate watering and water drainage for the multi-layer horticultural structure.

In preference the shoulder or chute of the overflow level arrangement of each flood tray drains or discharges into a chute which is connected to a flood tray located at an adjacent layer below.

In preference the aperture of the flood tray is positionable such that water discharging from said aperture will flow into said modulated chute.

An advantage of such an arrangement is that the modulated chute is able to construct its own inter-connected drainage network as one layer is built upon another in order to construct the multi-layer horticultural unit.

In preference the top of the chute has an opening which tapers inward and ends in an extended shoulder of a comparable dimension to the opening to which the nozzle of the water release outlets can be passed therethrough.

In preference each flood tray has a plant tray that is adapted to rest thereupon.

In preference the plant tray includes a series of slots, slits, holes and so forth so that water inside the flood tray can inter-engage with the plant, soil, substrate, seedlings, saplings and so forth.

This invention amongst others provides the following advantages and consideration.

Unlimited number of trays per grouping to be watered. Limitations on height and length of a group is only determined by pump capabilities and fluid frictional losses within the required piping system.

A single pump and water flow control valve per group of growing trays. The alternative for such a large number of trays would be large numbers of solenoid valves or a great deal of removable piping and direct mechanical connections to each tray.

Simultaneous and precisely equal flooding and draining of all trays in the group. No single flood tray is able to receive any greater depth of water or be watered for any longer period of time than another.

Ability to hold flooded state for any time period desired across entire group. Once nutrient jetted into each flood tray has reached the preset depth required for optimum plant watering, excess water spills over the weir edge of the flood tray, is collected by the drain chutes between each layer of trays and returned to the nutrient reservoir.

Total control over intervals between flood cycles. Number of flood cycles per day can be infinitely varied to suit different crop species and also different phases of growth during a plants growth cycle.

Easily remove trays from system for cleaning, planting or harvesting without having to disconnect or remove any mechanical, electrical or plumbing connections. Jet and Inlet port design means no mechanical attachment to the grow tray which automatically aligns itself with each tray upon its insertion into the racking system

Maintenance of a safe and sterile growing environment through the design of the grow tray and flood tray as a combination unit. This approach allows for removal of both trays as a single unit from the system for effective cleaning, seeding or harvesting. Having the flood tray always beneath the grow tray eliminates constant leakage of nutrient from grow trays as they are moved about inside a facility and also enables the flood tray to be efficiently cleaned and sterilized as opposed to normal flood and drain systems where the flood tank is a fixed structure unable to be easily cleaned.

Grow trays always totally covering their individual flood tray from essential growing lights greatly inhibits the development of unwanted nutrient consuming algae and bacteria that are generally dependant on light for photosynthetic growth

Automatic gravity driven recirculation of all nutrient feed water back to central reservoir for filtration, sterilization and nutrient conditioning

No flow of nutrients or organic matter from any tray directly to any subsequent trays beneath it

The venturi effect initiated during flood cycles forcibly aerates the nutrient entering the flood tray thus enhancing plant root oxygen levels essential for optimum growth rates. This action is due to a defined ratio between the diameter and flow rate of nutrient jet and the diameter and mechanical properties of the inlet port in flood tray.

### BRIEF DESCRIPTION OF THE DRAWINGS

In order now to describe the invention in greater detail a preferred embodiment will be presented herewith with the assistance of the accompanying illustrations.

Nonetheless it is to be kept in mind that the preferred embodiment is presented only to present a complete working embodiment of the invention however all the features discussed for the most part are optional with the essential aspects of the invention having been previously discussed in the summary of the invention listed above.

FIG. 1 is a perspective view of a multi-layer horticultural structure that includes the water supply network piping arrangement and its relationship with the respective water flood trays making up the structure.

FIG. 2 is a part tear-away perspective view of a close-up of the inter-relationship between the nozzle of the water release outlets and the configuration or alignment with the aperture of the flood tray.

FIG. 3 is a similar side view representation to what has been presented in FIG. 2.

FIG. 4 is a perspective view illustrating the feature associated with the modulated drainage chutes which inter-connect to provide a means for which drained and/or overflow water can move its way down within the drainage network of the multi-layer horticultural structure regardless of its layered position withinside the structure.

FIGS. 5a, 5b and 5c show representative perspective views of the kinds of plant trays that would be available to rest within the corresponding flood tray in the preferred embodiment of this invention.

### DETAILED DESCRIPTION OF THE INVENTION

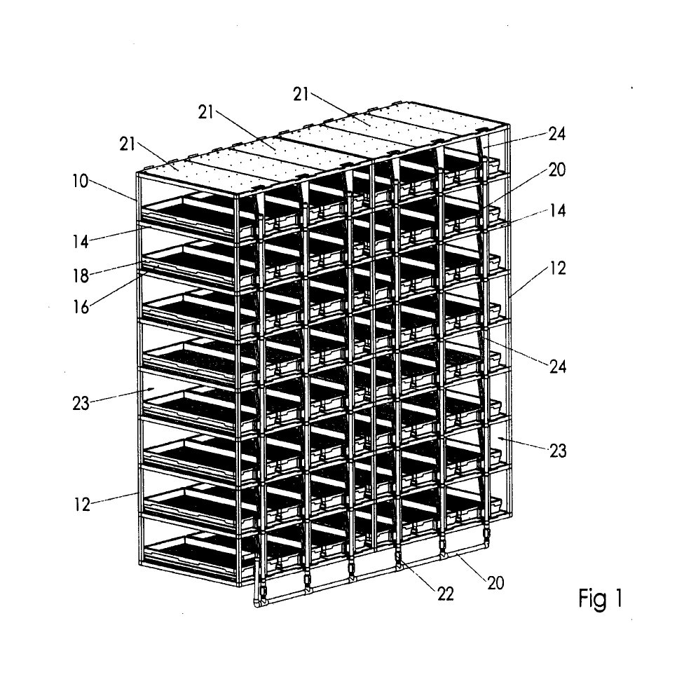

Referring to the illustrations now in greater detail wherein FIG. 1 shows generally as number (10) the multi-layer horticultural structure.

The multi-layer horticultural structure (10) includes main vertical upright supports (12) and horizontal or lateral platforms (14) which provide the skeletal main body structural support for the arrangement.

The multi-layer horticultural structure is divided up into six columns shown generally as (21) and in the embodiment shown in FIG. 1 there are eight rows shown generally as (23) each having six individual flood trays (16) where therein resting withinside the flood trays are the corresponding plant trays (18).

The water supply network piping is made up of the series of conduits (20), which in this preferred embodiment includes regulated control valves or flow regulators (22) for each one of the columns (21) making up the multi-layer horticultural structure (10).

As the person skilled in the art can appreciate the actual number of columns, rows and the corresponding water supply network piping is only conditional on the available space and environmental conditions including lighting and so forth that is available in the location to where this unit will need to operate.

Working in conjunction with the water supply network piping (20) is a series of inter-connected modulated chutes (24) which provide the drainage mechanism to accept water that is overflowing from each of the respective flood trays (16) as well as when water is deliberately drained from the aperture of the flood tray during times of discharge.

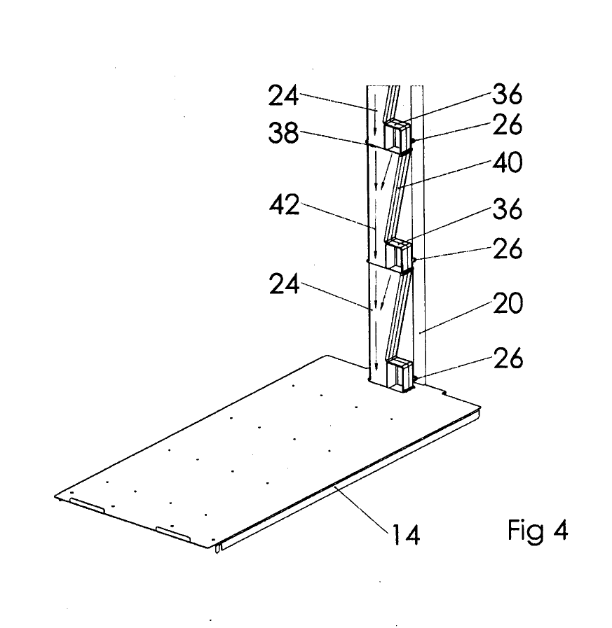

The structure and functionality of the inter-connecting modulated chutes that form the drainage network (24) are discussed in greater detail in connection with FIG. 4.

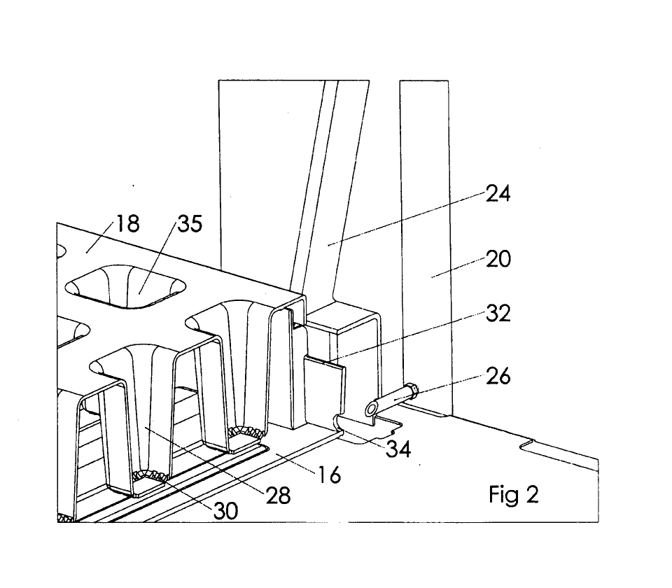

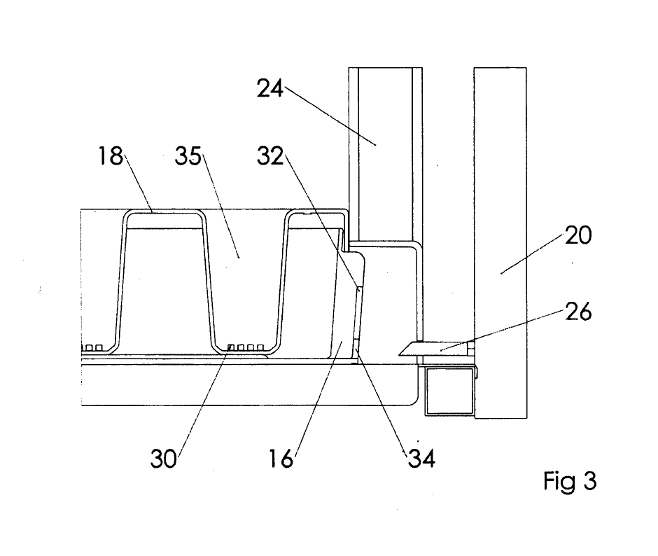

In FIGS. 2 and 3 the close-up representation is able to illustrate how the upright conduits (20) of the water supply network piping includes a series of nozzles (26) which act as the water release outlets once water is pumped into that particular conduit (20).

The water release outlet nozzle (26) is aligned so that when water is jetted, sprayed or flowed from the nozzle it is able to flow directly into the aperture (34) of the flood tray (16).

As discussed precedingly when generally describing the invention once the water is sprayed in through the aperture (34) of the flood tray (16) the water level can continue to rise withinside the flood tray (16) until the overflow level (32) has been reached, so that the shoulder (32) configured as part of the overall design of the flood tray (16) means that as further water is jetted into the flood tray (16) from the nozzle (26) water will then overflow and enter the drainage arrangement through the inter-connected modulated chutes (24) to also have a unique design configuration which will be discussed in greater detail in FIG. 4.

As can be seen from FIGS. 2 and 3 in this embodiment the plant tray (18) includes a series of depressed cylindrical shape type cones (35) which have a series of holes (30) which allows water to interact with the substrate material shown generally as (28) withinside these cone shaped depressions (35).

Therefore when a set level of water needs to be maintained withinside the arrangement the aperture (34) does not need to be closed off as water is continually supplied through the nozzle (26) to the flood tray however the level of water withinside the tray does not exceed a desired level as any excess water simply overflows through the shoulder (32) out through the drainage network provided by the integrated inter-connected modulated chutes (24).

FIG. 4 shows how the drainage network is established through the inter-connecting of the modulated chutes (24) which build up the drainage structure associated with the water supply network piping.

The top edge of ridge (38) is of a broader width so as to align itself with the incline drainage portion (40) of an upwardly adjacent modulated chute (24) but also then to cover the shoulder lateral extension (36) to which the nozzle (26) is adapted to be inserted therethrough.

The lateral tab (36) also provides a spacing to allow the overflow to pass there into but as arrows (42) in FIG. 4 illustrate water coming from flood trays at higher located rows withinside the multi-layer horticultural structure are able to drain all the way down through the structure by the inter-connecting of the respective modulated chutes (24).

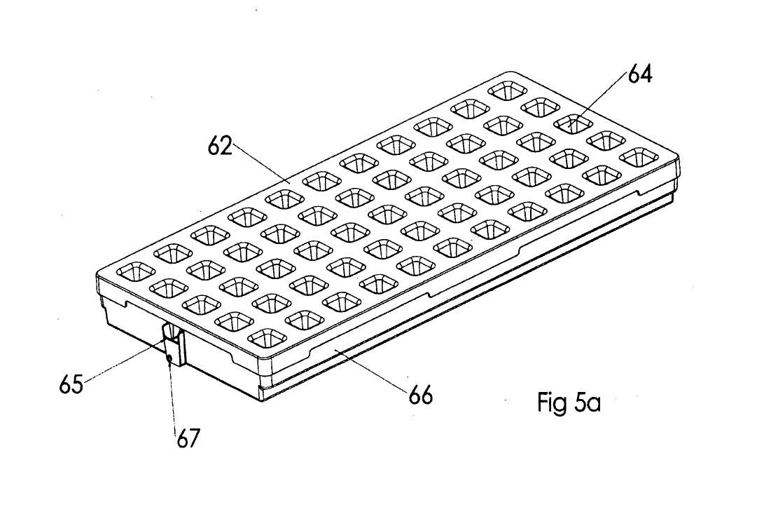

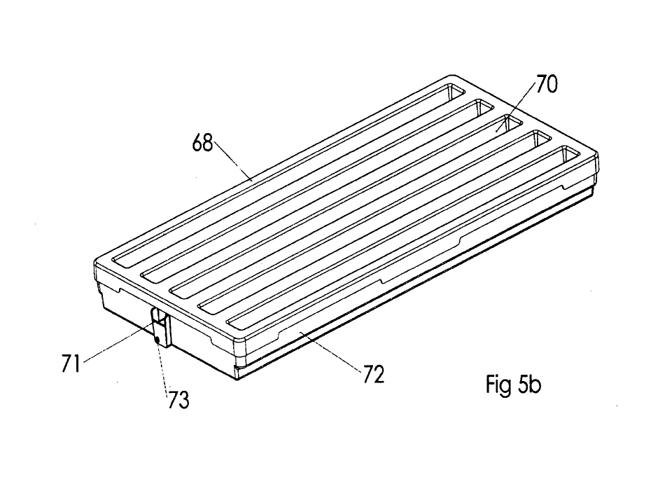

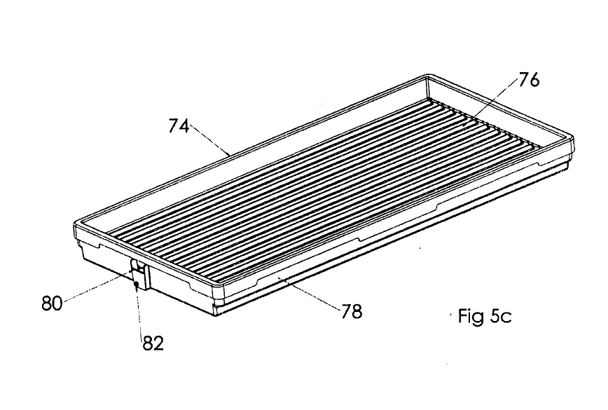

FIGS. 5a, 5b and 5c simply just show the variety of different embodiments that will be available for the plant tray that is adapted to rest upon the flood tray. These embodiments are shown as a selection of a much wider range that the person skilled in the art would realise are available to the horticulturalist.

In FIG. 5a the plant tray (62) includes a series of depressed tetrahedral-type ridges or holes (64) wherein the plant tray (62) rests upon the flood tray (66) wherein the flood tray (66) includes the aperture (67) to allow water to be jetted therethrough along with the overflow edge (65) once the desired level of water withinside the flood tray (66) has been reached.

In FIG. 5b the plant tray is listed as (68) to which it then rests upon the flood tray (72). The plant tray (68) in this embodiment in FIG. 5b includes a series of depressed ridges (70) and the flood tray (72) includes the aperture (73) for water to be jetted therethrough the flood tray (72) along with the necessary overflow edge (71) so that water can be discharged once the desired level of water has been achieved withinside the flood tray (72).

FIG. 5c shows the plant tray (74) with the main depression (76) wherein the plant tray (74) rests within the flood tray (78) including the aperture (82) for water to be jetted therethrough along with the overflow edge (80) so that water may be discharged there from overflow edge (80) once the desired level of water withinside the flood tray (78) has been reached.

1. A watering and water drainage arrangement for a multi-layer horticultural structure, the arrangement including;
a water supply network piping wherein the water supply network piping includes a series of water release outlets;
at least one flood tray per layer of the multi-layer horticultural structure;
each flood tray including an overflow level arrangement so that water introduced into the flood tray is unable to exceed a selected level as water will flow over a weir edge once the selected water level have been reached;
each flood tray further including an aperture to which water may be received or drained therethrough;
the water release outlets configured so that upon supply of water to the water supply network piping, water is sprayed from a distance into the flood tray aperture,
such that during watering sprayed water from the series of water release outlets water through the aperture flood tray fills the water flood tray to the selected level and when water level inside the water flood tray reaches the selected level this level is maintained by the continued supply of water from the water supply network piping water release outlet through the aperture of the flood tray while at the same time any additional delivery of water from the water supply network piping selected water level is reached sees a corresponding drainage or release of water from the overflow a weir edge of the flood tray,
and such that when drainage of water is required from each flood tray, supply of water to the release outlets is terminated by removing the supply of water from the water supply network piping which stops water being sprayed into the aperture of the flood tray thereby allowing the discharge of water through the aperture of the water flood tray.

2. The watering and water drainage arrangement of claim 1 wherein the water release outlet is a cylindrical nozzle.

3. The watering and water drainage arrangement of claim 1, wherein the aperture provides a selectable diameter.

4. The watering and water drainage arrangement of claim 1, wherein the overflow of water from the flood tray through the weir edge is arranged for the water to be drained into a modulated chute which is connected to a flood tray located at an adjacent layer below.

5. The watering and water drainage arrangement of claim 4 wherein the aperture of the flood tray is positionable such that water discharging from said aperture will flow into the modulated chute.

6. The watering and water drainage arrangement of claim 5 wherein the top of the modulated chute has an opening which tapers inward and ends in an extended shoulder of a comparable dimension to the opening to which the nozzle of the water release outlets can be passed therethrough.

7. The watering and water drainage arrangement of claim 1 wherein each flood tray has a plant tray that is adapted to rest thereupon.

8. The watering and water drainage arrangement of claim 7 wherein the plant tray includes a series of slots, slits and/or holes so that water inside the flood tray can inter-engage with plants, soil, substrate, seedlings, saplings contained in the plant tray.

9. The watering and water drainage arrangement of claim 7 further including a single pump and water flow control valve per grouping plant trays.

10. The watering and water drainage arrangement of claim 7 wherein the flood and plant trays are adapted to be removed from the arrangement for cleaning, planting or harvesting without having to disconnect or remove any mechanical, electrical or plumbing connections.

11. The watering and water drainage arrangement of claim 10 wherein the plant and flood tray are a combination unit such that removal of both trays is possible as a single unit from the arrangement for effective cleaning, seeding or harvesting.
